(19) United States
(12) Patent Application Publication
(10) Pub. No.: US 2025/0149688 A1
(43) Pub. Date: May 8, 2025

(54) ELECTROCHEMICAL ENERGY STORAGE CELL

(71) Applicant: VARTA Microbattery GmbH, Ellwangen Jagst (DE)

(72) Inventors: Ludwig Geiss, Nördlingen (DE); Horst-Udo Jose, Ellwangen (DE); Klaus-Bernd Ried, Ellwangen (DE)

(21) Appl. No.: 18/937,073

(22) Filed: Nov. 5, 2024

(30) Foreign Application Priority Data
Nov. 7, 2023 (EP) 23208411.1

(51) Int. Cl. H01M 50/107; H01M 4/02; H01M 4/42; H01M 4/50; H01M 50/119; H01M 50/133

(52) U.S. Cl. CPC H01M 50/107; H01M 50/119; H01M 50/133; H01M 2004/021; H01M 2004/027; H01M 2004/028; H01M 4/42; H01M 4/50; H01M 2300/0014

(57) ABSTRACT

An electrochemical energy storage cell includes a housing with a metal housing cup and a housing lid. The housing cup includes a circular bottom and a circumferential shell. The energy storage cell includes a positive and a negative electrode arranged in the housing. One of the electrodes, preferably the positive electrode, is formed as a hollow cylindrical electrode and encloses a cavity in which the other electrode, preferably the negative electrode, is arranged. The bottom of the housing cup has an annulus-shaped first region, in which the hollow-cylindrical electrode rests on the bottom of the housing cup, and a circular central second region, which is enclosed by the first region. The bottom of the housing cup has at least one notch in the first annulus-shaped region, which structurally weakens the bottom of the housing cup.

### CROSS REFERENCE TO RELATED APPLICATIONS

This application claims benefit to European Patent Application No. EP 23208411.1, filed on Nov. 7, 2023, which is hereby incorporated by reference herein.

### FIELD

The present disclosure relates to an electrochemical energy storage cell having an overpressure protection.

### BACKGROUND

In electrochemical energy storage cells an electrochemical, energy-supplying reaction takes place, which is made up of two electrically coupled but spatially separated partial reactions. A partial reaction that takes place at a comparatively low redox potential takes place at a negative electrode. A partial reaction that takes place at a comparatively high redox potential takes place at a positive electrode. During discharge, electrons are released at the negative electrode as a result of an oxidation process, resulting in a flow of electrons via an external consumer to the positive electrode, from which a corresponding amount of electrons is absorbed. A reduction process therefore takes place at the positive electrode. At the same time, an ion current corresponding to the electrode reaction occurs within the energy storage cell for the purpose of charge equalization. This ion current is ensured by an ion-charging electrolyte. Usually, the electrodes are separated by a separator. Accordingly, usually an electrochemical energy storage cell comprises at least one positive electrode and at least one negative electrode as well as at least one separator that separates the positive and negative electrodes from each other.

Alkaline manganese cells are a frequently used type of energy storage cell. These cells comprise a positive electrode made of manganese dioxide and a negative electrode made of zinc and generally an alkaline electrolyte. Such an electrolyte can be formed on the basis of potassium hydroxide, for example. The positive electrode is often formed as a hollow cylinder, the outside of which contacts the inside of a metal cell housing. The negative electrode, which can be formed by a zinc paste in particular, is located inside this hollow cylinder. This negative electrode is separated from the surrounding positive electrode by a separator, whereby the separator physically separates the positive electrode from the negative electrode and at the same time allows ion transport between the two electrodes. The negative electrode is generally contacted via a pin-shaped metal current collector, which transfers the negative potential to a part of the cell's metal housing. The housing of such a cell usually comprises a housing cup and a lid. The pin-shaped current collector is preferably in direct electrical contact with the lid. An alkaline manganese cell of this type is described, for example, in EP 3245681 B1.

In WO 2011/023447 A1 an alkali-manganese cell is disclosed in which the outer, hollow cylindrical electrode is composed of several annular segments.

In many electrochemical energy storage systems, including alkaline manganese cells, gas can develop inside the cell. The cause of such gas development can be, for example, deep discharge of the cell, discharge due to an external short circuit or unintentional charging of the cell when it is installed in a series connection with reversed polarity. In all these cases, the resulting gases can cause excessive internal pressure, which can ultimately cause the cell to explode. To avoid this, the cells are generally equipped with a pressure relief mechanism that allows the excess pressure to escape.

In commercially available alkaline manganese cells, a pressure relief function is generally integrated into the lid of the cell housing. A rupture membrane is provided in a plastic seal that forms a structural unit with the lid component of the cell. In the event of overpressure, the rupture membrane bursts and gas and possibly electrolyte and/or components of the electrodes can escape via holes in a disc above the rupture membrane. To ensure the safe opening of the rupture membrane a distance is required between the rupture membrane and the disc. This results inevitably in a dead volume that cannot be filled with the electrochemically active components of the cell.

Other solutions comprise a burst function in the bottom of the housing cup. For example notches in the bottom of the housing cup, which serve as predetermined cracking points, are known. Additional measures must be taken, especially with alkaline-manganese cells, to prevent uncontrolled spraying out of liquids and possibly solid components of the cell in the event of gases protruding from the inside of the cell.

For example, DE 3337570 C2 discloses an energy storage cell in which a notch is provided in the center of the bottom of the housing cup. The bottom of the housing cup is covered by an end cap, which forms the positive pole of the cell. If the burst function is triggered, escaping material is slowed down by the overlying end cap.

U.S. Pat. No. 8,158,280 B2 discloses a cell with a disc welded onto the bottom of the housing cup. When the burst function is triggered, the disc bends open and pressure can escape via a gap between the disc and the bottom of the housing cup.

WO 2020/033090 A1 discloses an energy storage cell with a housing cup and a lid, wherein a weakening structure is provided in a range from the bottom of the housing cup to form a valve-like opening, in particular by means of a curved weakening line. If excessive internal pressure occurs in the cell, this weakening structure bends open in the manner of a valve so that gases can escape from it. A filter disc is also provided inside the cell to prevent the uncontrolled ejection of gases, liquids and any solid components from the inside of the cell.

### SUMMARY

In an embodiment, the present disclosure provides an electrochemical energy storage cell. The cell includes a housing including a metal housing cup and a housing lid, the housing cup including a circular bottom and a circumferential shell, the circular bottom including an annulus-shaped first region and a circular central second region enclosed by the first region. The cell also includes a positive electrode and a negative electrode arranged in the housing. The positive electrode is formed as a hollow cylindrical electrode and encloses a cavity in which the negative electrode is arranged. The hollow cylindrical electrode rests on the circular bottom of the housing cup in the annulus-shaped first region, and the circular bottom of the housing cup has at least one notch in the annulus-shaped first region that structurally weakens the circular bottom of the housing cup.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a longitudinal section through an energy storage cell;

FIG. 2 illustrates a longitudinal section through the bottom part of a housing cup of an energy storage cell;

FIG. 3 illustrates a longitudinal section through the bottom part of a housing cup of a further embodiment of an energy storage cell;

FIG. 4 illustrates a top view of the housing bottom of an energy storage cell;

FIG. 5 illustrates an oblique view from below of the housing bottom of the energy storage cell according to FIG. 4;

FIG. 6 illustrates a top view of the housing bottom of a further embodiment of an energy storage cell;

FIG. 7 illustrates an oblique view from below of the housing bottom of the energy storage cell according to FIG. 6; and

FIG. 8 illustrates a sectional view of a notch in the housing bottom of an energy storage cell.

### DETAILED DESCRIPTION

Against this background, the present disclosure provides an energy storage cell, in particular an alkaline-manganese cell, which ensures reliable and safe overpressure protection for the user and at the same time dispenses with additional components in connection with this overpressure protection and also enables optimum volume utilization inside the cell.

The electrochemical energy storage cell is characterized by the following features:
a. The energy storage cell comprises a housing with a metal housing cup and a metal housing lid;
b. The housing cup comprises a circular bottom and a circumferential shell;
c. The energy storage cell comprises a positive and a negative electrode arranged in the housing;
d. One of the electrodes, in particular the positive electrode, is formed as a hollow cylindrical electrode and encloses a cavity in which the other electrode, in particular the negative electrode, is arranged;
e. The bottom of the housing cup has an annulus-shaped first region, in which the hollow cylindrical electrode rests on the bottom of the housing cup, and a circular central second region, which is enclosed by the first region.

The energy storage cell according to the invention is further characterized by the following feature:
f. The bottom of the housing cup has at least one notch in the annulus-shaped first region, which structurally weakens the bottom of the housing cup.

In accordance with feature f., the overpressure protection of the energy storage cell is integrated into the bottom of the housing cup. This notch serves as a predetermined cracking point and ensures that overpressure can be relieved by gas protruding from the cell so that the cell does not explode in the event of such a case.

The positioning, design and geometry of the at least one notch in the bottom of the housing cup, which will be explained in more detail below, prevents gases, liquids and possibly solid components from escaping from the interior of the cell in an uncontrolled manner through the broken notch, which could pose a hazard to a user in the vicinity of the cell. A particular advantage of the energy storage cell is therefore that no further special precautionary measures need to be taken, such as additional components in the form of a welded-on end cap or a filter disc inside the cell, which would deflect material escaping from the cell.

The energy storage cell with the predetermined cracking point in the region of the bottom of the housing cup of the cell has the particular advantage that no bursting membrane is required in the housing lid. A dead volume as mentioned in the outset can be avoided, the construction of the lid may be simplified. This leads to an increase of the usable internal volume of the cell. The volume of the cell can be used almost completely for the electrochemically active components of the cell, so that the capacity of the cell is increased by up to 2%.

In addition, the bursting pressure can be set more precisely for a predetermined crack in the metal of the bottom of the housing cup than for a plastic part. In particular, the opening pressure can be adjusted to an accuracy of +1 bar in the case of a notch in a metal sheet with a suitable geometry. With a plastic seal, on the other hand, which is generally produced with multi-cavity molds, a range of +20 bar is the usual accuracy of the opening pressure setting. The particularly accurate setting of the opening pressure in the energy storage cell allows precise coordination between the opening pressure of the target cracking point and the bursting pressure of the cell and thus a particularly safe design that reliably prevents the cell from exploding.

In a preferred embodiment of the energy storage cell, the energy storage cell is characterized by at least one of the following additional features:
a. The circular central second region forms or comprises the deepest region of the bottom of the housing cup;
b. The annulus-shaped first region comprises an outer annulus-shaped subregion which forms an angle of 80° to 100°, in particular 90°, with the housing cup shell and which immediately adjoins the housing cup shell;
c. The annulus-shaped first region comprises an inner annulus-shaped subregion that forms a transition between the outer annulus-shaped subregion and the circular central second region.

In a preferred manner, the aforementioned features a. and b. and, most preferably, the aforementioned features a., b. and c. are realized in combination with one another.

Preferably, the outer annulus-shaped subregion and the circular central second region each comprise a planar region. The outer annulus-shaped subregion preferably has an annulus-shaped planar region. The circular central second region preferably has a circular planar region.

It is preferred that the inner annulus-shaped subregion forms a transition between the planar regions of the outer annulus-shaped subregion and the circular central second region.

Preferably, the outer annulus-shaped subregion of the first region, in particular the plane region of the outer annulus-shaped subregion of the first region, and the circular central second region, in particular the plane region of the circular central second region, are at an angle of between 80° and 100°, in particular 90°, to the circumferential surface of the housing cup shell.

Preferably, the planar region of the outer annulus-shaped subregion is provided in a first plane and the planar region of the circular central second region is provided in a second plane, wherein the two planes are distanced from each other.

In some preferred embodiments the inner annulus-shaped subregion comprises a planar region. The inner annulus-shaped subregion preferably has an annulus-shaped flat region.

Preferably, the planar region of the inner annulus-shaped subregion is provided in a third plane, wherein the third plane is at a distance to the first plane and to a second plane.

In preferred embodiments, the transition between the planes of the outer annulus-shaped subregion and the circular central second region can be formed as per one of the following additional features:
a. The inner circular subregion forms a step between the planes of the outer circular subregion and the circular central second region.
b. The inner annulus-shaped subregion forms a continuous transition between the planes of the outer annulus-shaped subregion and the circular central second region.

In preferred embodiments the circular central second region forms a protrusion in the center of the bottom of the housing cup when viewed from the outside. The protrusion can be for example a pin-shaped or a dome-shaped protrusion. The protrusion can serve as the connection pole of the cell.

The annulus-shaped subregions of the bottom of the housing cup surrounding this connection pole can, for example, form two steps in accordance with the aforementioned feature a., the transitions of which can be formed as a direct step or slightly beveled.

Alternatively, the inner annulus-shaped subregion can have a hollow truncated cone-like, oblique shape and thus form a continuous transition in accordance with feature b. above.

The design of the energy storage cell according to the aforementioned feature a. with a stepped profile is preferred. In this case, the annulus-shaped subregions of the first region are provided in two planes in the bottom of the housing cup, which surround the protruding connection pole, i.e. the circular central second region. It is preferable if these planes have flat regions that are at an angle of 90°+10° to the housing shell. In this case, the outer annulus-shaped subregion and preferably also the inner annulus-shaped subregion form an angle of approximately 90° with the housing cup shell.

In preferred embodiments, the hollow cylindrical outer electrode rests exclusively on the outer annular subregion of the bottom of the housing cup.

In preferred examples, this cup bottom profile is adapted as for commercially available dimensions of energy storage elements. For example, the energy storage cell may be a cell with the battery size LR6. The outer diameter of the outer annulus-shaped subregion can, for example, be in a range from 13.6 to 14.4 mm, preferably 13.7 to 14.0 mm, in particular 13.8 mm. This outer diameter corresponds approximately to the outer circumference of the housing of the cell.

Furthermore, the outer diameter of the inner annulus-shaped subregion of the first region of the bottom of the housing cup can be in a range from 8 to 10 mm, for example, preferably 9.2 mm.

The diameter of the circular central second area, which preferably forms the connection pole of the cell, can, for example, be in a range from 4 to 5.5 mm, in particular 5.0 mm.

The profile of the bottom of the housing cup can, for example, be produced in a deep-drawing process during the production of the housing cup.

In a preferred embodiment of the energy storage cell, the energy storage cell is characterized by the additional feature a. immediately below:
a. The at least one notch is located in the inner annulus-shaped subregion of the first region of the bottom of the housing cup.

In an alternative, preferred embodiment of the energy storage cell, the cell is characterized by the following additional feature a. immediately below:
a. The at least one notch is located in the outer annulus-shaped subregion of the first region of the bottom of the housing cup.

The position of the at least one notch in the outer annulus-shaped subregion of the bottom of the housing cup in accordance with the aforementioned feature a. ensures that the notch is located in the region of the bottom of the housing cup which is adjacent to the hollow cylindrical electrode. This electrode is generally made of porous material. In the event of a burst, gas and possibly liquids protruding from the inside of the cell must pass through at least large parts of this porous material before they can escape via the burst bottom. This retains particulate components and prevents uncontrolled spraying out of materials.

In a preferred embodiment of the energy storage cell, the cell is characterized by at least one of the following additional features:
a. The notch is located on the outward-facing side of the bottom of the housing cup;
b. The notch is not covered on the outside by a metallic element.

Preferably, the aforementioned features a. and b. are realized in combination with each other.

According to the present disclosure, uncontrolled protruding from of liquids and possibly solid or particulate components in the event of bursting can be reliably avoided without the need for an additional component like a welded-on end cap mentioned at the outset.

Further, the energy storage cell preferably has no filter or perforated discs or similar components inside the cell. In the prior art, for example in WO 2020/033090 A1, energy storage cells have been proposed which are equipped with filter or perforated discs which are intended to prevent uncontrolled ejection, in particular of particulate components, from the interior of the cell in the event of bursting. Such filter or perforated discs are not required for the energy storage cells.

In preferred embodiments of the energy storage cell, the notch is characterized by at least one of the following additional features a. to c. immediately below:
a. The notch is formed as a straight line, at least in a section of the notch;
b. The length of the notch is at most half the diameter of the bottom of the housing cup;
c. The length of the notch is greater than the width of the inner and/or of the outer annulus-shaped subregion.

Preferably, the aforementioned features a. and b., or a. and c., or b. and c., or, most preferably, the aforementioned features a. to c. are realized in combination with one another.

It may further be preferred that the length of the notch is greater than the diameter of the circular central second region.

In a preferred manner, a single notch is provided in the bottom of the housing cup of the cell.

By forming the notch as a straight line, or at least in a section of the notch as a straight line, it is avoided that parts of the bottom of the housing cup can bend open, as would be the case with a semi-circular notch, for example. This would significantly enlarge the opening, allowing material to escape from the inside of the cell in an uncontrolled manner. This does not occur with the notch. By forming the notch as a straight line bending up of parts of the bottom of the housing cup is avoided, so that there is no enlarged opening through which material could escape. Overall, the linear design of the notch means that only a narrow opening is created when the burst pressure is reached, which can even partially close again when the internal pressure in the cell drops later due to the tension of the surrounding metal. Conventional solutions with semi-circular, crescent or star-shaped predetermined breaking points, on the other hand, create large openings when they are opened, through which liquid and solid battery components can escape from explosively. Such conventional solutions therefore require additional protection against protruding material, for example by means of a welded-on disc or a filter element.

In some embodiments, it may be preferred that the at least one notch, preferably the only notch, in the bottom of the housing cup is located off-center of the center of bottom of the housing cup, such that it is asymmetrical.

The length of the notch can be 5 to 7 mm, for example 6 mm, particularly in the case of a cell whose housing has a diameter of around 13 to 15 mm.

With regard to the geometry of the at least one notch and preferably the only notch in the bottom of the housing cup, the energy storage cell is preferably characterized by one of the additional features a. and b. immediately below:
a. The bottom of the housing cup has the at least one notch in the inner annulus-shaped subregion, wherein the notch is formed as a straight line, at least in a section of the notch, and the notch formed as a straight line or its section formed as a straight line is oriented in such a way that it does not intersect the annulus-shaped central second region even when extrapolated.
b. The bottom of the housing cup has the at least one notch in the outer annulus-shaped subregion, wherein the notch is formed as a straight line, at least in a section of the notch, and the notch formed as a straight line or its section formed as a straight line is oriented in such a way that it does not intersect the inner annulus-shaped subregion even when extrapolated.

Here, the aforementioned features a. and b. are to be understood as alternatives.

Preferred is the alternative according to the aforementioned feature b., according to which the at least one notch and preferably exactly one notch is located in the outer annulus-shaped subregion of the bottom of the housing cup.

In a preferred embodiment of the energy storage cell, the energy storage cell is further characterized by at least one of the additional features a. to c. immediately below:
a. The notch is covered by a plastic film on the outside of the housing;
b. The plastic film is applied to the shell and furthermore at least partially covers the annulus-shaped first region, in particular the outer annulus-shaped subregion of the first region, of the bottom of the housing cup;
c. The plastic film is a label.

In a preferred manner, the aforementioned features a. and b. and, most preferably, the aforementioned features a, b and c are realized in combination with one another.

It is particularly advantageous if the at least one notch is located in the outer annulus-shaped subregion of the first region of the bottom of the housing cup, so that the plastic film can cover the notch. The plastic film covering the notch further inhibits the uncontrolled escape from the cell of gaseous or liquid components. Particularly in combination with the positioning of the notch in the outer annulus-shaped subregion of the bottom of the housing cup, this provides particularly reliable protection against the escape of materials.

The plastic film can be a multi-layer film, for example a multi-layer film with a total thickness of 40 to 80 μm, for example 55 μm. Suitable materials for this are in particular PET (polyethylene terephthalate) or PVC (polyvinyl chloride) or PE (polyethylene). Such materials are already known for the application of battery labels on such energy storage cells.

A plastic material as an energy storage cell label on the shell has the further special advantage that it has an electrically insulating effect.

As explained above, the bottom of the housing cup of the cell is preferably characterized by a multi-step cross-section profile, with the notch preferably located in the outer step of the profiled housing bottom.

In particular, the outer step of the correspondingly profiled housing bottom is preferably covered by the plastic film. Preferably, only the outer step of the bottom of the housing cup is covered by the plastic film.

When manufacturing the cell, the plastic film can be applied and shrunk on in the form of a tube, for example. It is advantageous if the plastic film is applied during this process in such a way that its edges cover the notch in the bottom of the housing cup of the cell.

In preferred embodiments, the energy storage cell is characterized by at least one of the additional features a. to c. immediately below:
a. The notch has a trapezoidal cross-section with two side walls and a bottom and one open side;
b. The notch widens starting from its bottom;
c. The two side walls enclose an angle in a range from 50 to 80°, preferably in a range from 53 to 57°.

Preferably, the aforementioned features a. and b., or a. and c., or b. and c., or, preferably, the aforementioned features a. to c. are realized in combination.

Such a geometry of the notch ensures in a particularly reliable manner that, in the best case, no uncontrolled protruding of material from the inside of the cell occurs.

In preferred embodiments, the notch has the trapezoidal cross-section according to the aforementioned feature a., with the two side walls enclosing an opening angle of 55°.

With regard to the geometry of the at least one notch of the energy storage cell, the cell is further characterized in a preferred manner by at least one of the following additional features:
a. The wall thickness of the bottom of the housing cup is reduced in the region of the bottom of the notch by 60 to 90%, preferably by 70 to 80%, compared to the wall thickness of the bottom of the housing cup in the immediate vicinity of the notch;
b. The bottom of the housing cup has a wall thickness of 0.15 to 0.30 mm, preferably 0.20 to 0.25 mm, in the immediate vicinity of the notch, i.e. outside the region of the bottom of the notch;
c. The bottom of the housing cup has a wall thickness of 0.03 to 0.09 mm, preferably of 0.04 to 0.08 mm, preferably of 0.05 to 0.07 mm, in the region of the bottom of the notch.

In preferred embodiments of the energy storage cell, the cell is characterized in particular by a combination of the aforementioned features a. and b., and, most preferably, by a combination of the aforementioned features a. to c.

In preferred examples of embodiment, the remaining wall thickness in the region of the bottom of the notch can in particular be in a range from 20% to 30% of the remaining wall thickness of the bottom of the housing cup in the immediate vicinity of the notch, for example the remaining wall thickness can be 21% or 22% or 29% or 30% of the remaining wall thickness of the bottom of the housing cup.

The wall thickness of the bottom of the housing cup outside the notch can be in a range from 0.23 to 0.24 mm, for example.

The wall thickness in the area of the cylindrical housing shell can be in a range from 0.14 to 0.18 mm for size LR6, for example.

In preferred examples, the wall thickness (residual wall thickness) in the region of the bottom of the notch is 0.05 mm or 0.07 mm.

Tests by the inventors have shown that relatively little electrolyte escapes from a bottom of the housing cup with an asymmetrical notch and the preferred geometry described above in the event of a burst. Furthermore, there is no escaping of solid components of the cell. In particular in comparison with other cells which have, for example, an arc-shaped notch in the bottom of the housing cup, so that the housing bends open in the event of bursting, significantly less material is released. With the notch, a gentle opening takes place, so to speak, and only a little material escapes from the cell in a controlled manner.

In further preferred embodiments of the energy storage cell, the cell is characterized by the additional feature a. immediately below:
a. The wall thickness of the bottom of the housing cup in the region of the bottom of the notch is one to four times the distance between the wall sides at the bottom of the notch.

The distance between the side walls at the bottom of the notch corresponds to the width of the notch at its bottom. Preferably, this is the narrowest point of the notch.

In preferred examples of the energy storage cell, the wall thickness of the bottom of the housing cup in the region of the bottom of the notch is, for example, 2.5 times or 3.5 times the distance between the side walls at the bottom of the notch.

In preferred embodiments, the energy storage cell is further characterized by at least one of the additional features a. and b. immediately below:
a. The distance between the side walls at the bottom of the notch is 5 to 30%, preferably 8 to 15%, of the wall thickness of the bottom of the housing cup in the immediate vicinity of the notch;
b. The distance between the side walls at the bottom of the notch is in a range from 0.01 to 0.08 mm, preferably from 0.02 to 0.07 mm, preferably in a range from 0.02 mm to 0.03 mm.

Preferably, the two aforementioned features a. and b. are realized in combination with each other.

In preferred examples, the distance between the side walls at the bottom of the notch is between 8 and 15%, preferably between 11 and 13% of the wall thickness of the bottom of the housing cup in the immediate vicinity of the notch.

In preferred examples, the distance between the side walls at the bottom of the notch is 0.02 mm to 0.03 mm.

In preferred examples, the energy storage cell is characterized by the additional feature a. immediately below:
a. The at least one notch of the electrochemical energy storage cell is formed such that the bottom of the housing cup tears open along the notch at a pressure in a range from 40 to 105 bar.

In preferred examples, the opening pressure is, for example, in a range from 40 to 90 bar or in a range from 55 to 105 bar.

Due to the arrangement and geometry of the notch, the opening pressure can be set very precisely and adapted to the respective application. In particular, the opening pressure can be adjusted by adapting the residual wall thickness in the region of the bottom of the notch. For example, if the residual wall thickness is elevated from 0.05 mm to 0.07 mm, the pressure at which the target crack opens increases.

In a preferred example of an energy storage cell of size LR6, the notch in the bottom of the housing cup has an opening angle of 55°, with the lower width of the notch being 0.02 mm. The wall thickness of the bottom of the housing cup outside the notch is preferably 0.23 to 0.24 mm, with the wall thickness (residual wall thickness) in the bottom area of the notch preferably being 0.05 mm. This notch is designed in particular for an opening pressure of 40 to 90 bar. The notch according to this example is preferably located in the inner annulus-shaped subregion of the first region of the bottom of the housing cup. However, the notch can also be located in the outer annulus-shaped subregion of the first region of the bottom of the housing cup.

In another preferred example of size LR6, the opening angle of the notch in the bottom of the energy storage cell is also 55° and the width of the notch at its bottom is 0.02 mm. The wall thickness of the bottom of the housing cup outside the notch is 0.23 to 0.24 mm, whereby the wall thickness in the bottom area of the notch is 0.07 mm. This notch is designed as a predetermined cracking point, in particular for an opening pressure of 55 to 105 bar. The notch according to this example is preferably located in the outer annulus-shaped subregion of the first region of the bottom of the housing cup.

Preferably, the energy storage cell is characterized by at least one of the following additional features:
a. The positive electrode is a manganese oxide electrode;
b. The negative electrode is a zinc electrode;
c. A separator is arranged between the positive electrode and the negative electrode;
d. The energy storage cell comprises an alkaline electrolyte.

In preferred examples of embodiment, the aforementioned features a. and b. are realized in combination with one another. In a preferred embodiment, the aforementioned features a. to d. are realized in combination with one another.

In the embodiment according to the aforementioned features a. to d., the energy storage cell is an alkaline-manganese cell.

In particular, potassium hydroxide solution, i.e. an aqueous solution of potassium hydroxide, can be used as an alkaline electrolyte.

In alkaline manganese cells, the positive electrode is formed as the hollow cylindrical electrode and the negative electrode is arranged in the cavity thereof. The anode can comprise, for example, a zinc powder or a zinc alloy powder. For example, a mixture comprising a zinc alloy powder, alkaline electrolyte and a gelling agent is suitable. The positive electrode preferably consists of pressed manganese dioxide (manganese dioxide).

In a simple embodiment, the positive electrode can, for example, be formed by an inner coating of the metal housing cup with manganese dioxide. In other embodiments, the hollow cylindrical cathode can be composed of annular individual segments that adjoin each other on their contact surfaces.

Such alkaline manganese cells have special requirements with regard to safety functions. Typically, the burst pressures of commercially available alkaline manganese cells of type LR6, for example, are about 60 bar. When a burst membrane in the housing cup of such a cell is opened, there is therefore a potential risk of electrolyte and, in particular, parts of the negative electrode escaping from the cell at a relatively high speed in an uncontrolled manner. For this reason, commercially available alkaline manganese cells are generally equipped with a rupture membrane in or below the lid. This common embodiment of a bursting function in an alkaline manganese battery with the associated disadvantages has already been mentioned at the beginning.

In contrast, the inventors were able to show that a reliable bursting function for an alkaline-manganese cell that meets the safety requirements can be realized with at least one notch in the housing bottom in accordance with the design of this notch. In particular, such a notch can reliably rupture at the intended opening pressure and serves to relieve pressure. At the same time, the design and positioning of the notch prevents uncontrolled leakage and splashing out of liquid and possibly solid components from the interior of the energy storage cell, so that no further precautions against such uncontrolled splashing out are required, such as a cover cap or a filter disc provided inside the cell or similar.

The housing cup for the housing of the energy storage cell can, for example, be formed as a deep-drawn part and can, for example, consist of nickel-plated steel. The at least one notch can, for example, be produced during the deep-drawing process. In other embodiments, the at least one notch can also be embossed onto the bottom of the housing cup, for example.

In a preferred embodiment of the energy storage cell, a single notch is provided in the bottom of the housing cup of the cell formed as an alkaline-manganese cell. The notch is located off-center and does not extend through the center of the bottom of the housing cup. The notch is strictly linear and has a length that corresponds to less than 50% of the diameter of the bottom of the housing cup. The notch is located in a range from the outside of the bottom of the housing cup, is open to the outside and has a trapezoidal cross-section that widens outwards.

Further features are illustrated in the following description of working examples in conjunction with the drawings.

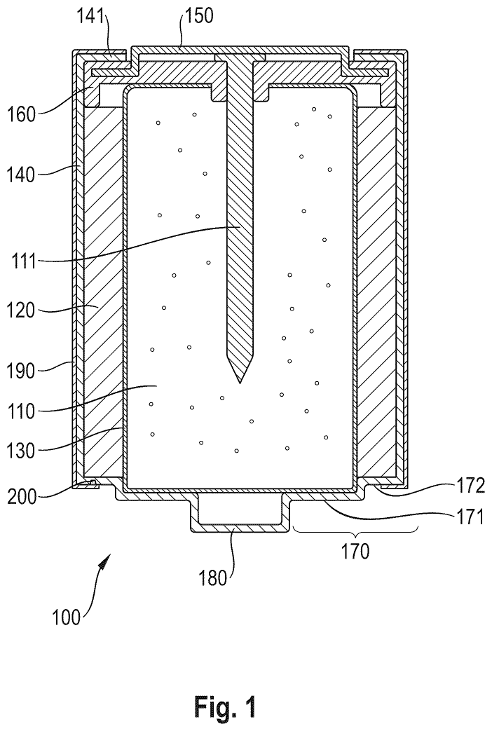

FIG. 1 shows a longitudinal section of a cylindrical energy storage cell 100, in an embodiment of an alkaline-manganese cell. The energy storage cell 100 comprises a negative zinc electrode 110, which is enclosed by a hollow cylindrical positive electrode 120. The hollow cylindrical electrode 120 consists essentially of manganese oxide. In the center of the inner electrode 110 is a pin-shaped metal current collector 111. A separator 130 is arranged between the inner, negative electrode 110 and the hollow-cylindrical, positive electrode 120, which separates the electrodes from each other and is permeable to ions.

The cathode 120 can be formed from pressed manganese oxide (manganese dioxide). The cathode can thereby form a ring within the energy storage cell 100, which is in direct electrical contact with the metal housing cup 140. The anode 110 is preferably formed from a paste of zinc powder and potassium hydroxide as electrolyte. This paste can, for example, be inserted into an ion-permeable filter paper or cloth, which can serve as separator 130.

The electrodes 110, 120 are located within a metal housing formed by a housing cup 140 and a housing lid 150. The housing lid 150 is fixed by a bent-over edge 141 of the housing cup 140 and is insulated from the housing cup 140 and from direct contact with the inner electrode 110 and the hollow-cylinder-shaped outer electrode 120 by means of a plastic seal 160. The pin-shaped current collector 111 penetrates the plastic seal 160 via a hole and is in direct, electrically conductive contact with the housing lid 150.

The housing bottom of the housing cup 140 comprises an annulus-shaped first region 170 and a circular central second region 180. The annulus-shaped first region 170 is subdivided into an inner annulus-shaped subregion 171 and an outer annulus-shaped subregion 172. The transitions between the subregions or planes of the bottom of the housing cup are formed step-like. The hollow cylindrical outer electrode 120 rests on the outer annulus-shaped subregion 172 of the bottom of the housing cup.

The circular central second region 180 forms the deepest region of the bottom of the housing cup and serves as a connection pole of the energy storage cell 100, in this case the positive connection pole. Accordingly, the lid 150 on the opposite side of the energy storage cell 100 forms the negative pole. In other embodiments, it may also be provided that the inner electrode has a positive polarity and the outer, annular electrode has a negative polarity, so that overall the polarity of such an energy storage cell would be reversed.

The cylindrical energy storage cell 100 has a circumferential housing shell, which is provided with a plastic film 190 attached thereto. The plastic film 190 can serve as a cell label and can be provided with various information in written and/or pictorial form. Furthermore, the plastic film 190 has an insulating function.

According to the present disclosure, the energy storage cell 100 is provided with a notch 200. The notch 200 is provided in the first region 170 of the bottom of the housing cup. In the example shown here, the notch 200 is located in the outer annulus-shaped subregion 172. The notch 200 is covered by the plastic film 190.

The notch 200 enables pressure equalization in the event of an internal pressure in the energy storage cell 100 exceeds a predefined level, so that an explosion of the energy storage cell 100 does not occur. The notch 200 is formed such that it can cause a gentle opening, so to speak, when notch is torn open, so that there is no uncontrolled spraying out of liquids and possibly solid components that could harm a person in the immediate vicinity of the energy storage cell 100. Controlled escape is achieved in particular by the geometry and positioning of the notch.

Preferably, the notch is formed as a straight line, at least in a section of the notch. When the notch is opened, the opening is not enlarged in an uncontrolled manner.

Further, in the preferred example shown here, the notch 200 is located in a region of the bottom on which the hollow cylindrical outer electrode 120 rests, so that gases and liquids must first penetrate the porous material of this electrode. This has the effect that particulate components in particular are retained and the outflow of gases and liquids is slowed down.

Furthermore, in this preferred example, the notch 200 is covered by the outer plastic film 190. The plastic film 190 also further slows down the protruding from of gases and liquids.

In other embodiments, such a notch 200 may also be arranged in the inner annulus-shaped subregion 171.

The starting material for the production of the housing cup can be a sheet metal having a thickness of 0.25 mm, for example. The deep-drawing process during the manufacture of the housing cup causes the material to stretch in the region of the shell, so that the wall thickness in the region of the shell is usually in a range from 0.14 mm to 0.18 mm, for example. This stretching hardly occurs at the bottom of the housing cup, so that the wall thickness in the region of the bottom of the housing cup (outside the notch) is usually about 0.23 mm or 0.24 mm.

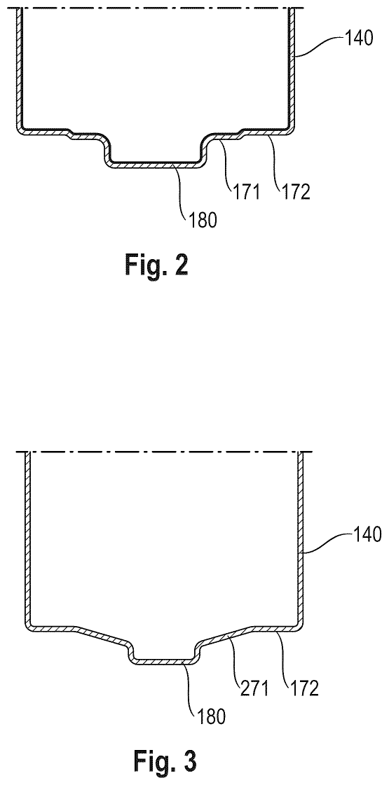

FIG. 2 illustrates the multi-step profile of the bottom of the housing cup 140 by means of an enlarged detailed view. The bottom of the housing cup shows a stepped profile with the circular central region 180 and the annulus-shaped outer region, which is subdivided into an inner annulus-shaped subregion 171 and an outer annulus-shaped subregion 172. The connection pole of the cell on this side of the energy storage cell is formed by the protruding central region 180, which forms the deepest region of the bottom of the housing cup. In contrast to older proposals for bursting elements integrated in the bottom of the housing cup (e.g. according to DE 3337570 C2), no additional metallic element in the form of an end cap is welded onto the housing here, which would form the respective pole.

In the energy storage cell 100, the metal housing cup 140 with the stepped housing base profile is formed in one piece. The first step of the bottom of the housing cup, i.e. the outer annulus-shaped region 172, comprises an annulus-shaped planar region. This planar region forms a right angle with the circumferential housing cup shell.

The second step, i.e. the inner annulus-shaped region 171, also comprises an annulus-shaped planar region. And the central region 180 comprises a circular planar region. Also these planar regions form right angles to the circumferential housing shell of the housing cup 140.

The transitions between the steps of the housing bottom of the housing cup are preferably formed as right-angled edges, whereby the transitions can also be rounded and/or beveled.

The notch provided, which is not shown here, can be located in the region of the inner annulus-shaped subregion 171 or, preferably, in the region of the outer annulus-shaped subregion 172.

FIG. 3 shows an alternative embodiment of the bottom of the housing cup 140. Here too, a circular central region 180, an outer annulus-shaped subregion 172 and an annulus-shaped circular subregion 271 are provided. Unlike the step-like inner annulus-shaped subregion of FIG. 2, the inner annulus-shaped subregion 271 in this embodiment forms a continuous, beveled transition between the planes of the outer annulus-shaped subregion 172 and the circular central region 180, which forms the deepest region of the bottom of the housing cup.

The notch provided, which is not shown here, can be located in the region of the inner annulus-shaped subregion 271 or, preferably, in the region of the outer annulus-shaped subregion 172.

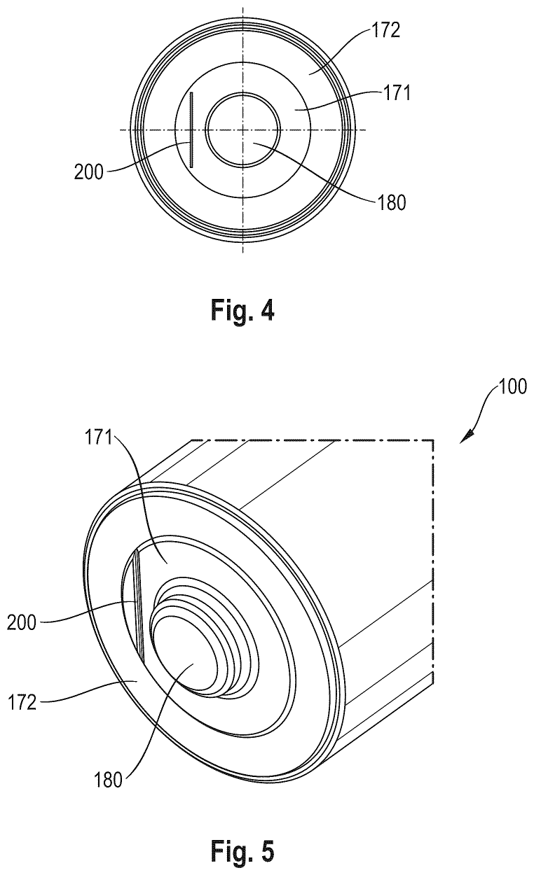

FIG. 4 shows a top view of the housing bottom with the circular central region 180, the inner annulus-shaped subregion 171 and the outer annulus-shaped subregion 172. In this example, the notch 200 of the bottom of the housing cup is arranged off-center in the inner annulus-shaped subregion 171. In this example, the notch 200 is formed as a strictly linear straight line. The length of the notch 200 is approximately as long as the diameter of the circular central region 180.

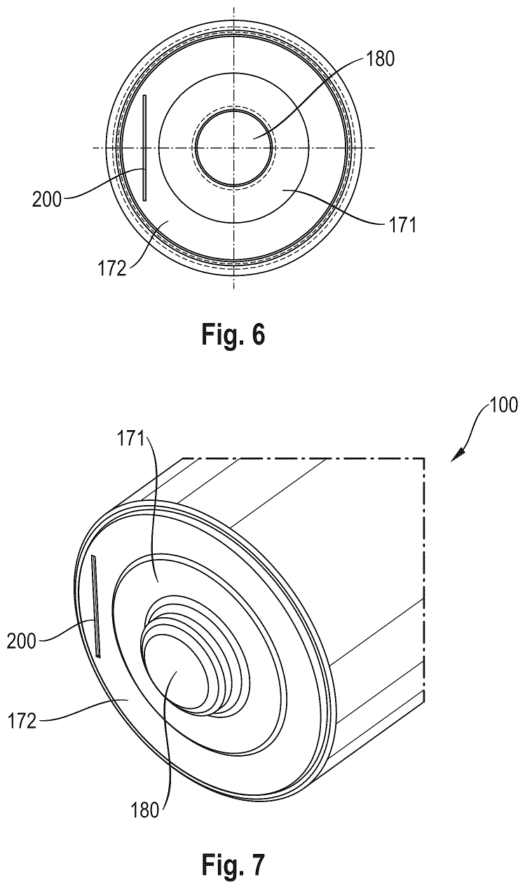

FIG. 5 shows the bottom of the housing cup of the energy storage cell 100 according to FIG. 4 in an oblique view from below. The notch 200 is arranged in the inner annulus-shaped subregion 171 and has a strictly linear shape. The notch 200 is arranged eccentrically and extends up to the transition to the outer annulus-shaped subregion 172.

FIG. 6 shows a preferred embodiment of the energy storage cell 100, in which the strictly linear notch 200 is positioned in the outer annulus-shaped subregion 172 of the bottom of the housing cup.

The particular advantage of this arrangement has been described above.

A further advantage of the position of the notch 200 in the outer annulus-shaped subregion 172 is that the notch 200 is preferably covered by the plastic film attached to the housing shell of the cell, which also covers the edge regions of the two end faces of the cylindrical cell. This also further slows down the outflow of gases and/or liquids from the predetermined cracking point in the event of a burst.

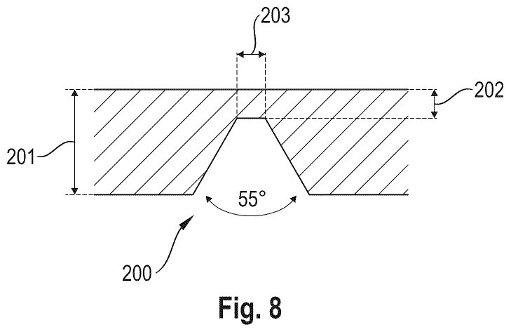

FIG. 7 illustrates the arrangement of the notch 200 according to the example shown in FIG. 6 in an oblique view of the energy storage cell 100 from below. The illustration clarifies the position of the notch with a strictly linear course in the outer partially circular region 172 of the bottom of the housing cup.

FIG. 8 shows further preferred details of the geometry of the notch 200. The notch 200 has a trapezoidal cross-section and widens towards the outside of the energy storage cell. In this preferred example, the opening angle is 55°. The wall thickness 201 of the housing bottom outside the region of the notch 200 can for example be 0.23 mm to 0.24 mm. The wall thickness 202 in the region of the bottom of the notch can for example be in a range from 0.05 mm to 0.07 mm. The distance 203 between the side walls at the bottom of the notch, i.e. the width of the notch in its bottom area, is preferably in a range from 0.02 mm to 0.03 mm in this example. With a housing diameter of 13.8 mm, the length of the notch is for example 6 mm.

This preferred geometry of the notch 200 is designed for an opening pressure of between 40 and 90 bar with a wall thickness 202 (residual wall thickness) in a range from 0.05 mm in the region of the bottom of the notch, whereby the inventors were able to determine a narrow pressure distribution for the bursting pressure of 63±1 bar with this specific design of the notch.

If the wall thickness 202 in the region of the bottom of the notch is 0.07 mm, for example, the opening pressure of the notch is 55 to 105 bar.

These specific geometries of the notch 200 are particularly suitable for commercially available designs of alkaline manganese cells, for example LR6 or LR03 cells.

Due to the position of the notch 200 in the metal housing bottom and the geometry of the notch 200, the burst pressure can be set very precisely and with a standard deviation of +1 bar, for example. This behavior of the notch 200 was tested under various possible failure scenarios, for example when the cell was deeply discharged (<0.1 V), when there was an external short circuit and/or when it was charged and stored at different temperatures. In all these possible failure cases, it was found that a reliable pressure relief function is realized with a notch 200 having the proposed design and position, which reliably avoids uncontrolled escape of liquids and solids.

In addition to the reliable and, for the user, particularly safe bursting function provided by the notch, the energy storage cell also has the particular advantage that no burst function needs to be provided in the lid, so that the seal arranged there and the lid can be designed cavity-free. This means that the internal volume of the cell can be used to the maximum for the cell's electrochemical active material.

The geometry of the notch and the position of the notch in the bottom of the housing cup of the cell ensure that only a very fine gap opens in the event of a burst and that only gas and electrolyte, but no solid components of the cell, escape. Compared to conventional designs of a bursting membrane, particularly in the seal in the region of the lid construction of a cell, the amount of electrolyte escaping from the cell is also lower, so that there is less danger to the user.

When the notch is arranged in the outer annulus-shaped subregion of the first region in the bottom of the housing cup, the electrolyte protruding from the cell must first penetrate the outer hollow cylindrical electrode, in particular the porous cathode, in the event of a burst. This also further reduces the pressure and the amount of electrolyte escaping from the cell and minimizes the potential hazard to a user.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An electrochemical energy storage cell, comprising:
a housing comprising a metal housing cup and a housing lid, the housing cup comprising a circular bottom and a circumferential shell, the circular bottom comprising an annulus-shaped first region and a circular central second region enclosed by the first region; and
a positive electrode and a negative electrode arranged in the housing;
wherein the positive electrode is formed as a hollow cylindrical electrode and encloses a cavity in which the negative electrode is arranged;
wherein the hollow cylindrical electrode rests on the circular bottom of the housing cup in the annulus-shaped first region, and
wherein the circular bottom of the housing cup has at least one notch in the annulus-shaped first region that structurally weakens the circular bottom of the housing cup.

2. The energy storage cell of claim 1, wherein at least one of:
the circular central second region forms or comprises the deepest region of the bottom of the housing cup;
the annulus-shaped first region comprises an outer annulus-shaped subregion that forms an angle of 80 to 100° with the shell and that immediately adjoins the shell;
the annulus-shaped first region comprises an inner annulus-shaped subregion that forms a transition between the outer annulus-shaped subregion and the circular central second region.

3. The energy storage cell according to claim 2, wherein at least one of:
the inner annulus-shaped subregion forms a step between the planes of the outer annulus-shaped subregion and the circular central second region;
the inner annulus-shaped subregion forms a continuous transition between the planes of the outer annulus-shaped subregion and the circular central second region.

4. The energy storage cell according to claim 2, wherein at least one notch is located in the inner annulus-shaped subregion of the first region of the bottom of the housing cup.

5. The energy storage cell according to claim 2, wherein the at least one notch is located in the outer annulus-shaped subregion of the first region of the bottom of the housing cup.

6. The energy storage cell according to claim 1, wherein at least one of:
the notch is located on the outward-facing side of the bottom of the housing cup;
the notch is not covered on the outside by a metallic element.

7. The energy storage cell according to claim 1, wherein at least one of:
the notch is formed as a straight line, at least in a section;
the length of the notch is at most half of the diameter of the bottom of the housing cup;
the length of the notch is greater than the width of the inner and/or of the outer annulus-shaped subregion.

8. The energy storage cell according to claim 1, wherein at least one of:
the circular bottom of the housing cup has the at least one notch in the inner annulus-shaped subregion, wherein the notch is formed as a straight line at least in a section, and the notch formed as a straight line or its section formed as a straight line is oriented such that it does not intersect the annulus-shaped central second region even when extrapolated;
the bottom of the housing cup has the at least one notch in the outer annulus-shaped subregion, wherein the notch is formed as a straight line at least in a section, and the notch formed as a straight line or its section formed as a straight line is oriented such that it does not intersect the inner annulus-shaped subregion even when extrapolated.

9. The energy storage cell according to claim 1, wherein at least one of:
the notch is covered by a plastic film arranged on the outside of the housing;
the plastic film is applied to the shell and furthermore at least partially covers the annulus-shaped first region of the bottom of the housing cup;
the plastic film is a label.

10. The energy storage cell according to claim 1, wherein at least one of:
the notch has a trapezoidal cross-section with two side walls and a bottom and one open side;
the notch expands from the bottom;
the two side walls enclose an angle in a range from 50 to 80°.

11. The energy storage cell of claim 10, wherein at least one of:
the wall thickness of the bottom of the housing cup is reduced in the region of the bottom of the notch by 60 to 90% compared to the wall thickness of the bottom of the housing cup in the immediate vicinity of the notch;
the bottom of the housing cup has a wall thickness of 0.15 to 0.30 mm in the immediate vicinity of the notch;
the bottom of the housing cup has a wall thickness of 0.03 to 0.09 mm in the region of the bottom of the notch.

12. The energy storage cell according to claim 10, wherein the wall thickness of the bottom of the housing cup in the region of the bottom of the notch is one to four times the distance between the side walls at the bottom of the notch.

13. The energy storage cell according to claim 10, comprising at least one of:
the distance between the side walls at the bottom of the notch is 5 to 30% of the wall thickness of the bottom of the housing cup in the immediate vicinity of the notch;
the distance between the side walls at the bottom of the notch is in a range from 0.01 to 0.08 mm.

14. The energy storage cell according to claim 1, wherein at least one notch of the energy storage cell is formed such that the bottom of the housing cup tears open along the notch at a pressure in a range from 40 to 105 bar.

15. The energy storage cell according to claim 1, wherein at least one of:
the positive electrode is a manganese oxide electrode;
the negative electrode is a zinc electrode;
a separator is arranged between the positive electrode and the negative electrode;
the energy storage cell comprises an alkaline electrolyte.
